(19) United States
(12) Patent Application Publication
(10) Pub. No.: US 2021/0253463 A1
(43) Pub. Date: Aug. 19, 2021

(54) TREATMENT OF WASTEWATER WITH BIOREFRACTORY COMPOUNDS SUCH AS PULP MILL WASTEWATER

(71) Applicant: BL TECHNOLOGIES, INC., Minnetonka, MN (US)

(72) Inventors: Sven BAUMGARTEN, Ratingen (DE); Moreno DIPOFI, Milan (IT); Pablo CANADA GARCIA, Milan (IT)

(21) Appl. No.: 17/251,085

(22) PCT Filed: Jun. 27, 2019
(86) PCT No.: PCT/US2019/039525

§ 371 Date: Dec. 10, 2020

(30) Foreign Application Priority Data
Jun. 28, 2018 (IT) 102018000006764

(51) Int. Cl. C02F 9/00; C02F 1/44; C02F 3/12; B01D 69/02; B01D 69/12; B01D 61/18

(52) U.S. Cl. CPC C02F 9/00; C02F 1/444; C02F 3/1268; C02F 2103/28; B01D 69/02; B01D 69/12; B01D 61/18; C02F 1/441

(57) ABSTRACT

In a system and process described herein, wastewater such as pulp mill wastewater is treated with a membrane bioreactor (MBR) or another biological process coupled with tertiary filtration. An intermediate filtrate such as permeate from the membrane bioreactor is then treated with a tight ultrafiltration membrane optionally having a molecular weight cut-off of 500-4,500 Da on polyethylene glycol. Optionally, concentrate from the ultrafiltration membrane is sent to a black liquor evaporator of the pulp mill.

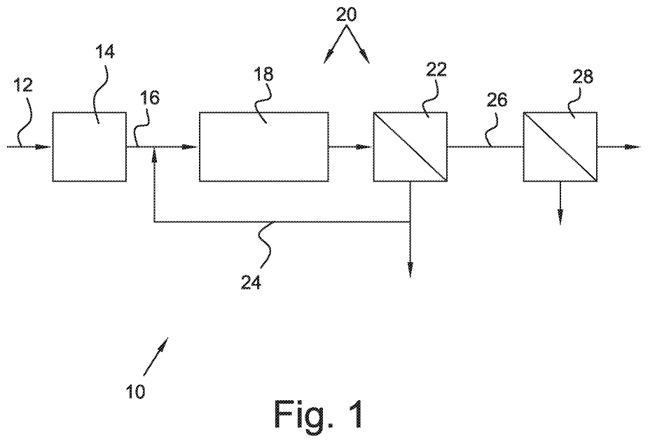

### FIELD

This specification relates to wastewater treatment, for example treating wastewater from a pulp mill.

### BACKGROUND

Pulp mills, or pulp and paper mills, frequently treat their wastewater on site. In many cases, the treatment includes a primary physical separation. This may be done in a clarifier or, less frequently, by dissolved air flotation. The primary effluent is then treated biologically. Biologic treatment can include, for example, an activated sludge process or aerated lagoon or, less frequently, a sequencing batch reactor or moving bed bioreactor.

Membrane technologies are not commonly proposed for treating pulp mill wastewater. In one example, Neves et al., in Pulp and Paper Mill Effluent Port-Treatment Using Microfiltration and Ultrafiltration membranes, described laboratory scale studies in which MF and UF membranes treated effluent from a secondary decanter that is part of an activated sludge system at a pulp and paper mill. The microfiltration (MF) membrane had an average pore size of 0.4 um. The ultrafiltration (UF) membrane had a 50 kDa molecular weight cut-off. COD was reduced from 948 mg/L in the feed water to 163-210 and 184-255 in the permeate of the UF and MF membranes respectively. In another example, Lerner et al., in Comparative Study of MBR and Activated Sludge in the Treatment of Paper Mill Wastewater, compared a full scale activated sludge plant with a parallel operated membrane bioreactor (MBR) with flat sheet membranes. The MBR produced effluent with less suspended solids. However, other effluent quality parameters such as organic matter (COD and BOD), phosphorous and ammonia nitrogen were not substantially improved with the MBR and the MBR required more complicated maintenance.

### SUMMARY

The following summary is intended to introduce the reader to the detailed description to follow and not to limit or define the claimed invention.

In a pulp mill, conventional biological treatment may remove most of the biochemical oxygen demand (BOD) but only about 40 to 85% of the chemical oxygen demand (COD), depending on the pulping process and the material (wood) used in the process. Some organic matter, including for example relatively high molecular weight organic compounds, is not easily removed by biodegradation. These compounds, which may be called bio-refractory compounds, resist removal mechanisms in a typical activated sludge process, such as digestion, sorption and phase separation. In the context of a pulp mill, lignin is a significant bio-refractory compound.

In a system and process described herein, wastewater such as pulp mill wastewater is treated with a membrane bioreactor (MBR) or by a biological process followed by tertiary filtration. Effluent from the membrane bioreactor or tertiary filter is then treated with a tight ultrafiltration membrane optionally having a molecular weight cut-off of 500-4,500 Da on polyethylene glycol. Optionally, concentrate from the ultrafiltration membrane is sent to a black liquor evaporator of the pulp mill.

Without intending to be limited by theory, the inventors believe that some wastewaters such as pulp mill wastewater contain bio-refractory compounds such as lignin that are difficult to be treated biologically. The use of an MBR or tertiary filtration provides effluent with low suspended solids concentration and, in the case of the MBR, may improve biological treatment. The MBR or tertiary filtration effluent may be treated with a tight ultrafiltration membrane, optionally called a lignin removal membrane (LRM) in some examples herein. The pore size of the membrane, as specified for example by molecular weight cut-off, is selected to reject bio-refractory compounds without rejecting significant salinity. This allows a high recovery rate, for example 95% or more, to be achieved, optionally without the use of membrane influent conditioning chemicals. Optionally, reject (alternatively called concentrate or brine) from the membranes may be treated by an evaporative or distillation process, in some examples blended for treatment with black liquor from a Kraft or other pulp mill, for example in an evaporator. Alternatively, the membrane reject may be treated further, for example by way of coagulation, electrocoagulation, advanced oxidation processes or evaporation/crystallization. The membrane permeate had less than 100 mg/L COD in a single stage pilot system. It is estimated that in a full-scale multi-stage system the membrane permeate may have less than 50 mg/L COD.

### BRIEF DESCRIPTION OF FIGURE

The FIGURE is a schematic drawing of a wastewater treatment system.

### DETAILED DESCRIPTION

The system and process described herein allows for the separation of colloidal material including relatively high molecular weight organic compounds in effluent from a biological treatment system. These bio-refractory compounds are separated in a membrane process. In pulp mill wastewater, for example from a Kraft pulp mill, lignin is a significant bio-refractory compound in the wastewater. The system and process may also be used with other forms of wastewater having bio-refractory compounds. For example, paper mills also produce wastewater containing lignin, though typically at a lower concentration. Optionally, for the purpose of the illustrative example of treating pulp mill wastewater described further below, the membrane may be called a lignin removal membrane (LRM). Optionally, pulp mill wastewater (either the entire pulp mill effluent or one or more lignin-rich sub-streams produced within the pulp mill) may be sent to the biological treatment system directly, for example without dilution with water such as wastewater from another source.

MWCO values used in this specification refer to the nominal MWCO as usually understood in the art and/or specified by the manufacturer, which is the lowest molecular weight solute or molecule that is 90% retained by the membrane, typically as measured by rejection of dextran or polyethylene glycol of known molecular weight in solution by a sample of the membrane in a test cell. The LRM membrane may have a molecular weight cut-off (MWCO) of 4,500 Da or less or 3,500 Da or less. With a low MWCO, bio-refractory compounds such as lignin are transferred into a reject phase of the LRM. However, by selecting a membrane with a molecular weight cut-off at or above, for example, 500 Da, 1,000 Da or 1,500 Da, non-organics related salinity is only moderately increased in the membrane reject. In some classification schemes, nanofiltration (NF) membranes are described as having MWCO in the range of 120 to 1,000 Da and tight ultrafiltration membranes are described as having MWCO in the range of 1,000 Da to 3,000 Da. In this specification, the term “tight ultrafiltration membrane” is used to describe membranes having MWCO in the range of 500 to 4,500 Da. This includes some membranes that could be called NF membranes but without including the complete range of NF membranes, many of which would reject too much salinity to be desirable in the process described herein, for example because they are unlikely to be able to operate at the recovery rate desired and/or produce a concentrate stream that is acceptable for recycle to the black liquor evaporator of a pulp mill plant. To further reduce salt rejection, membranes having MWCO in the range of at least 1,000 Da or at least 1,500 Da may be used. We also include some membranes with slightly larger pores (i.e. up to 4,500 Da or up to 3,500 Da) since these can be expected based on the experimental data included herein to be effective in the process. The membranes are preferably thin film composite membranes having a textile fabric layer, a first membrane layer and a second layer. The second membrane layer may be made by interfacial polymerization, for example of a polyimide. These membranes tend to have tighter pore size distributions (i.e. shaper cut-off) than membranes with only one membrane layer, typically made by a non-solvent induced phase inversion (NIPS), thermally induced phase inversion (TIPS) or a stretching process, of the same nominal MWCO. Commercially available thin film membranes include the GK series (3,500 MWCO on polyethylene glycol), GH series (2,500 MWCO on polyethylene glycol), and GE series (1,000 MWCO on polyethylene glycol) available in spiral wound elements from Suez Water Technologies and Solutions.

High recovery rates of 95-99% or more in the LRM can be achieved, optionally without the aid of any feed water conditioning chemicals. An intermediate filtrate produced after biological treatment of wastewater may be fed essentially directly to the LRM. For example, the intermediate filtrate is not treated by way of flocculation, coagulation or precipitation. In some cases, the LRM permeate may meet stringent discharge requirements or be suitable for direct or indirect reuse. Optionally, the LRM permeate may be further treated, for example by reverse osmosis, to further enable re-use.

The LRM reject can be disposed of or treated further. In some examples, LRM reject is recirculated back into the pulp making process. For example, the LRM reject can be blended with the black liquor fed to the evaporators or other desalination unit in a Kraft or other pulp mill. By selection of an LRM that does not significantly increase reject salinity, an LRM reject is produced that does not increase a scaling or corrosion risk for the evaporators relative to treating the black liquor alone. In other examples, the LRM reject may be treated with dedicated physical and/or chemical treatment units. For example, the LRM reject may be treated further, for example by way of coagulation, electrocoagulation, advanced oxidation processes or evaporation/crystallization. Optionally, the LRM reject may be treated with a brine concentrator and crystallizer in a zero liquid discharge system. The LRM reject is relatively clean compared to typical pulp mill black liquor and may be suitable for use in a process to recover lignin as a product.

With more stringent discharge requirements to sensitive water bodies such as rivers and lakes, and the need for reduced water consumption or increased reuse of water, the removal of refractory compounds is becoming increasingly important. In pulp mills, macromolecular lignin compounds represent a major source of refractory compounds. Lignin compounds can be reduced by chemically enhanced coagulation and precipitation but this consumes chemicals and generates a significant amount of waste sludge. Further polishing of the chemical precipitation effluent by oxidation processes is also typically required to provide low COD treated water. In contrast, permeate produced by the LRM may have COD (i.e. color and/or lignin) concentrations low enough to permit discharge to surface water. Optionally, the LRM permeate may be further treated, for example desalinated, to provide water for re-use. In some examples, a reverse osmosis (RO) system is used to treat the LRM permeate. Concentrate from the RO system is increased in salinity but still low enough in COD to permit discharge to surface water. Permeate from the RO system may be used as process feed water.

The LRM membrane preferably operates with a recovery rate of 95% or more or 97% or more or 99% or more. Operating with a recovery rate less than 95% would produce a large amount of reject to be disposed or treated. Conversely, operating the LRM at a recovery rate of 99% and sending the reject to the black liquor evaporators increases the feed flow to the evaporators by only 2-3% even if all of the pulp mill wastewater is treated as described herein. The evaporator feed water quality is not worsened from a corrosion perspective when the LRM reject is added. However, operating at recovery rates in the range of 95% to 99% may also produce an acceptable amount of LRM reject, and might be preferred in examples where there are extremely stringent LRM permeate requirements (i.e. very low color or COD less than 35 mg/L) or where the overall economic analysis favors a recovery rate in this range.

The FIGURE shows a pulp mill wastewater treatment system 10. In this example, a blended stream including all of the pulp mill wastewater 12 is treated. Alternatively, one or more lignin rich sub-streams may be treated, which may improve the operation of the system 10 while also producing less water to be recycled to the black liquor evaporators. The pulp mill wastewater 12 is first treated in an optional pre-treatment unit 14. Pre-treatment unit 14 may include, for example, primary clarification or screening. Pre-treated effluent 16 is then treated biologically in one or more process tanks 18 of a membrane bioreactor (MBR) 20. The MBR 20 also has a membrane unit 22. The MBR 20 operates in an activated sludge process, with a return of activated sludge 24 to the process tank 18, but with the membrane unit 22 replacing a conventional secondary clarifier. The MBR produces high quality permeate 26, which flows to the downstream LRM unit 28. Typically, no coagulant or chemical precipitation agents are required to remove COD upstream of, in, or downstream of the MBR 20. If any coagulating or flocculating chemicals are used, they are preferably used upstream of membrane unit 22 rather than downstream of MBR 20. Optionally, chemical agents may be used to precipitate specific compounds such as phosphorous or improve the operational performance of the system.

In other examples, a tertiary filtration membrane (which may be similar to membrane unit 22 but typically without recycle of waste sludge) or other filter or solids removal process could be added between a conventional activated sludge system (i.e. after a secondary clarifier) or other biological treatment system (e.g. sequencing batch reactor (SBR) or moving bed bioreactor (MBBR)) and the LRM unit 28. For example, a loose (relative to the LRM) ultrafiltration membrane (for example with a pore size in the range of 0.01 to 0.1 micrometer, or about 0.04 micrometer (um) or more) could be placed between a secondary clarifier of a conventional activated sludge system, or other biological treatment system, and the LRM unit 28. This option may be preferable, for example, when retrofitting an existing pulp mill wastewater treatment system that already has a biological treatment system. Other filters such as cloth filters, disc filters, pleated fabric filters, microfiltration (MF) membrane filters, sand filters, surface filters or depth filters might also be used. However, fouling of the LRM unit 28 is a concern and so the membrane unit 22 or tertiary filter preferably removes substantially all suspended solids. Optionally, an additional filter can be provided upstream of the LRM to further protect the LRM membranes. A pore size of 1 micrometer or less or 0.1 micrometer or less, or substantial (i.e. 90% or more) removal of all solids larger than 1 micrometer or larger than 0.1 micrometer, is preferred.

The LRM unit 28 is equipped with tight UF membrane modules, for example spiral wound modules. The LRM modules have a nominal MWCO of, for example, 500 to 4,500 Da or 500 to 3,500 Da. Optionally, the MWCO may be 2,500 Da or less. Optionally, the MWCO may be 1,000 Da or more or 1,500 Da or more.

The tight ultrafiltration membrane allows for the rejection of colloidal material and macromolecules, such as lignin derivatives and organic nitrogen, that are permeable to the upfront MBR membranes or tertiary filter without significant rejection of salinity, for example chlorides but optionally other multivalent ions. However, due to the MBR or tertiary filter pre-treatment, recoveries of over 95%, over 97%, or optionally up to 99% or more can be provided in the LRM membranes.

The LRM unit 28 may have a single stage or multi-stage, e.g. two-stage, configuration, for example with permeate from the first stage sent to the second stage. The same or different tight UF membrane types can be used in the multiple stages.

With low rejection of salinity in the LRM unit, recirculation of the reject into the pulp mill process is possible. Low salinity also simplifies, and reduces the chemical and energy requirement, of some alternative LRM membrane reject treatment processes.

The MBR 20, or a tertiary filter, may use submerged ZEEWEEED 500 membranes from Suez Water Technologies and Solutions. These are hollow fiber membranes with a braided supporting tube and a PVDF separation layer with nominal 0.04 micrometer (um) pore size. The LRM unit 28 may use GK, GH or GE membranes. The GK membranes are available from Suez Water Technologies and Solutions. They are thin film ultrafiltration membranes with a molecular weight cut-off of 3,500 on polyethylene glycol. They are normally used in spiral wound modules. The GH and GE membranes are also available from Suez Water Technologies and Solutions. They are thin film ultrafiltration membranes with a molecular weight cut-off of 2,500 and 1,000, respectively, on polyethylene glycol, normally used in spiral wound modules.

In an example, all of the wastewater streams from a pulp mill such as a Kraft pulp mill or sulfite pulp mill are blended. The wastewater after pre-treatment in a primary clarifier has over 1500 mg/L COD and 2200 mg/L total dissolved solids (TDS). A conventional activated sludge system with a secondary clarifier would require chemical precipitation to meet a discharge limit of 100 mg/L COD, and also ozonation to meet lower discharge limits. With treatment of the combined pulp mill wastewater in an MBR or by tertiary filtration, permeate with COD of under 350 mg/L is produced. The MBR permeate can be further treated in the LRM unit to a COD of under 100 mg/L, optionally less than 50 mg/L. Optionally, one or more wastewater sub-streams from the pulp mill with particularly high lignin concentrations may be treated as described above while one or more sub-streams with lower lignin concentrations are treated conventionally.

### Examples

MBR permeate (extracted through an ultrafiltration membrane) from pulp mill wastewater was separated using UF flat sheet membranes, normally used in spiral wound membranes, mounted in a Sepa CFII test cell. Reduction of COD and color at various recovery rates was measured. Four sample membranes were tested. The GK and GH membranes are available from Suez Water Technologies and Solutions. They are thin film ultrafiltration membranes with a molecular weight cut-off of 3,500 and 2,500 Da on polyethylene glycol respectively. The PT and PW membranes are available from Suez Water Technologies and Solutions. They are polyethersulfone ultrafiltration membranes (single membrane layer formed by NIPS) with a molecular weight cut-off of 5,000 and 20,000 respectively.

The table below gives the concentration of COD in the permeate with the membranes operated at 23° C. The feed water contained 172 ppm COD as O₂. The GH and GK membranes had acceptable permeate COD and very little color apparent to the eye.

| | | | typical flux | COD |
|---|---|---|---|---|
| Membrane | Maximum | | (LMH @ | in ppm |
| type | pressure | MWCO | bar) | O₂ |
| GH | 27 bar | 2.5 kDa- | 34 @ 10.3 | 21 |
| | | PEG | | |
| GK | 27 bar | 3.5 kDa- | 29 @ 5.2 | 29 |
| | | PEG | | |
| PT | 10 bar | 5 k dextran | 153 @ 3.5 | 54 |
| PW | 10 bar | 20 k dextran | 144 @ 2.1 | 105 |

At a pilot plant, a membrane bioreactor (MBR) was installed to treat Kraft pulp mill wastewater. The MBR permeate (extracted through an ultrafiltration membrane) was fed to two downstream lignin removal membrane (LRM) pilot systems. The downstream pilot system had GK and GH spiral wound LRM modules. A feed pump feeds the MBR permeate to the LRM modules and provides recirculating crossflow through the membranes for fouling control. Automatic control of the pilot increase pressures in order to keep the permeate flow constant.

One LRM system has been operated at over 95% recovery for over 6 weeks with three cleanings using an acidic clean-in-place solution. The other LRM system has been operated at 99.2% recovery for 3 weeks with two cleanings using an acidic clean-in-place solution. Operation of both LRM systems under these conditions appears stable.

Color in the MBR permeate fed to the LRM units ranged from 250 to 550 Pt.Co during the periods of time mentioned above. Permeate color in both pilots was typically less than 100 PtCo. COD in the MBR permeate fed to the LRM units ranged from 150 to 350 mg/L during the periods of time mentioned above. Permeate COD was typically less than 100 mg/L in both pilots.

In another pilot study, wastewater from a Kraft pulp mill was treated biologically and with coagulation in an MBR. MBR permeate (extracted through an ultrafiltration membrane with 0.04 micrometer pores) was filtered through a 2.5″, 4″ and 8″ diameter spiral wound modules of GK membranes for 4 months, 4 months, and 3 month respectively. At some times, an additional cartridge filter was used between the MBR and the LRM. The pilot was operated with each module at recovery rates of 99% and 97%. The membranes were cleaned 1-2 times per week. The water fed to the LRM unit had up to 280 ppm COD and up to 750 mg/L PtCo. At least 80% COD removal and at least 85% color removal was achieved at both recovery rates. Chloride salinity in the LRM reject increased was about 250 mg/L compared to about 100 mg/L in the MBR permeate. The LRM reject was acceptable for return to the black liquor evaporation system of the pulp mill. For the 4″ module: average flux was about 20 LMH with a maximum of 32 LMH; average transmembrane pressure was about 7.5 bar; average sulfite rejection was 57%; and, average calcium rejection was 84%.

In another pilot study, wastewater from a sulfite pulp mill was treated biologically in an MBR. MBR permeate (extracted through an ultrafiltration membrane with 0.04 micrometer pores) was then filtered through a spiral would module of GK membranes. At some times, an additional cartridge filter was used between the MBR and the LRM. The pilot was operated for over 3 months at a recovery rate of 98% and average flux of about 20 LMH. The membranes were cleaned 1-2 times per week. The water fed to the LRM unit had up to 750 ppm COD. At least 85% COD removal was achieved.

Although the system and process is described above for use with pulp mill wastewater, the system and process may be useful with wastewater having bio-refractory COD, or COD of relatively high molecular weight size.

1. A process for treating pulp mill wastewater comprising,
treating the wastewater with a membrane bioreactor (MBR), or a biological treatment process followed by a tertiary filtration filter, to produce an intermediate permeate; and,
treating the intermediate permeate with a tight ultrafiltration membrane.

2. The process of claim 1 wherein the tight ultrafiltration membrane has a molecular weight cut-off of 500-4,500 Da on polyethylene glycol.

3. The process of claim 1 wherein the tight ultrafiltration membrane has a molecular weight cut-off of 500-3,500 Da on polyethylene glycol.

4. The process of claim 2 wherein the tight ultrafiltration membrane has a molecular weight cut-off of at least 1,000 Da on polyethylene glycol.

5. The process of claim 2 wherein the tight ultrafiltration membrane has a molecular weight cut-off of at least 1,500 Da on polyethylene glycol.

6. The process of claim 1 wherein concentrate from the tight ultrafiltration membrane is sent to a black liquor evaporator of the pulp mill.

7. The process of claim 1 comprising operating the tight ultrafiltration membrane at a recovery rate of 95% or more.

8. The process of claim 1 wherein the pulp mill wastewater is treated substantially without dilution.

9. The process of claim 1 wherein the intermediate permeate is sent essentially directly to the tight ultrafiltration membrane.

10. The process of claim 1 wherein permeate from the tight ultrafiltration membrane is desalinated, for example by treatment by reverse osmosis.

11. The process of claim 1 wherein the MBR or tertiary filtration filter comprises an ultrafiltration membrane.

12. The process of claim 1 wherein the tight ultrafiltration membrane is a thin film composite membrane.

13. An apparatus for the treatment of wastewater containing a biorefractory compound comprising,
a biological treatment unit coupled with a filter adapted to receive the wastewater and produce an intermediate filtrate;
a tight ultrafiltration membrane adapted to receive the intermediate filtrate and produce a permeate stream and a concentrate stream.

14. The apparatus of claim 13 wherein the tight ultrafiltration membrane has a molecular weight cut-off of 500-4,500 Da, 1,000 to 4,500 Da or 1,500 to 4,500 Da on polyethylene glycol.

15. The apparatus of claim 13 wherein the filter comprises an ultrafiltration membrane.
